(19) United States
(12) Patent Application Publication
(10) Pub. No.: US 2026/0359674 A1
(43) Pub. Date: Nov. 12, 2026

(54) SPECULATIVE DECODING WITH ADAPTIVE DRAFT LENGTHS

(71) Applicant: Advanced Micro Devices, Inc., Santa Clara, CA (US)

(72) Inventors: Sonali SINGH, Santa Clara, CA (US); Karthik Ramu SANGAIAH, Bellevue, WA (US)

(21) Appl. No.: 19/202,942

(22) Filed: May 8, 2025

(51) Int. Cl. G06N 5/04; G06T 1/20

(52) U.S. Cl. CPC G06N 5/04; G06T 1/20

(57) ABSTRACT

Embodiments herein describe an accelerator including draft length adjustment circuitry configured to determine a moving average acceptance rate for draft length tokens sequentially generated for a large language model (LLM) inference call using speculative decoding (SpD), compare the moving average acceptance rate to a threshold acceptance rate, and adjust a draft length based on the comparison to create an adjusted draft length. The draft length is incremented when the moving average acceptance rate is greater than the threshold acceptance rate. The draft length is decremented when the moving average acceptance rate is less than the threshold acceptance rate. The accelerator includes stepping point detection and adjustment circuitry configured to identify, after the adjusted draft length has been created, draft sequence lengths defined as stepping points that exhibit sudden upward bursts.

### TECHNICAL FIELD

Examples of the present disclosure generally relate to accelerators, and, in particular, to accelerators employing the large language model inference technique of speculative decoding with adaptive draft lengths.

### BACKGROUND

In large language model (LLM) inference, speculative decoding (SpD) has emerged as an effective technique for accelerating text generation by using a lightweight draft model to propose multiple tokens before validation by a more complex target model. Ideally, SpD provides significant speedups by reducing the number of sequential computations needed by the target model. However, observed speedups are often lower than the theoretical maximum due to inefficiencies in the verification phase. The process of checking and accepting or rejecting drafted tokens introduces latency, particularly when the target model re-computes probabilities for rejected tokens. As a result, the benefits of parallel speculative generation are partially offset by the sequential nature of the verification phase.

This slowdown is exacerbated when the draft model produces speculative tokens with low acceptance rates, which result in frequent re-evaluations by the target model. Additionally, resource contention between the draft and target models can lead to pipeline inefficiencies, further limiting the achievable speedup. In cases where many tokens are rejected, the system may revert to near-sequential processing, negating much of the intended acceleration. Addressing these bottlenecks involves exploring different mechanisms for reducing the slowdown during the LLM verification phase.

### SUMMARY

One example described herein is an accelerator including draft length adjustment circuitry configured to determine a moving average acceptance rate for draft length tokens sequentially generated for a large language model (LLM) inference call using speculative decoding (SpD), compare the moving average acceptance rate to a threshold acceptance rate, and adjust a draft length based on the comparison to create an adjusted draft length.

One example described herein is a processor including draft length adjustment circuitry configured to generate draft length tokens for a large language model (LLM) inference call using an artificial intelligence (AI) acceleration technique and stepping point detection and adjustment circuitry configured to identify, after the draft length adjustment circuitry has been used to adjust a draft length, draft sequence lengths defined as stepping points that exhibit abrupt upward spikes in latency.

One example described herein is a method including initializing a large language model (LLM) inference call using speculative decoding (SpD), setting an initial draft length and a threshold acceptance rate, generating draft length tokens, verifying the draft length tokens in parallel using a LLM, determining a moving average acceptance rate, comparing the moving average acceptance rate to the threshold acceptance rate, and adjusting the draft length based on the comparison to create an adjusted draft length.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates an accelerator employing dynamic draft length adjustment circuitry and stepping point adjustment circuitry, according to an example.

FIG. 2A illustrates employing speculative decoding (SpD) with variable draft length, according to an example.

FIG. 2B illustrates employing SpD with hardware-guided variable draft length, according to an example.

FIG. 3 is a block diagram of an accelerator unit (AU) configured to execute workloads for applications running on a processing system, according to an example.

FIG. 4 illustrates a method for employing SpD with variable draft length, according to an example.

FIG. 5 illustrates a method for employing SpD with hardware-guided variable draft length, according to an example.

FIG. 6 illustrates a method for adjusting the draft length based on a comparison between a moving average acceptance rate and a threshold acceptance rate to create an adjusted draft length, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the examples herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Large language models (LLMs) have become integral to a wide range of applications, from chatbots to code generation, due to their ability to generate coherent and contextually relevant text. However, their high latency, particularly during inference, presents a challenge. To address this, speculative decoding (SpD) has been introduced as a technique to accelerate text generation by using a lightweight draft model to propose multiple tokens ahead of time, which are then validated by the target LLM. Ideally, SpD enables near-linear speedups by reducing the number of sequential steps needed for token generation. However, practical implementations reveal that the observed speedups are often lower than the theoretical maximum, particularly when using large draft lengths.

One bottleneck arises during the LLM verification phase, where the target model evaluates and accepts or rejects the speculative tokens generated by the draft model. The efficiency of SpD hinges on the ability of the draft model to produce high-confidence tokens that the target model can quickly verify. However, as the draft length (K) increases, the likelihood of incorrect predictions rises, leading to frequent token rejections. This forces the target LLM to regenerate rejected tokens, introducing latency that diminishes the expected acceleration benefits. Thus, while increasing the draft length may seem beneficial, it can lead to diminishing returns due to increased overhead during verification.

One observation is that the forward pass latency of the target LLM during verification is not constant but instead grows non-linearly with the sequence length. This non-linearity exacerbates the slowdown in SpD, particularly for large draft lengths, where the verification cost per step becomes increasingly significant. As the sequence grows longer, the computational complexity of the self-attention mechanism in transformer-based architectures results in higher latency for each additional token verification. As such, verification overhead does not remain fixed, further explaining why real-world speedups fall short of theoretical predictions.

To address this challenge, an adaptive mechanism is needed to dynamically adjust the draft length based on the underlying hardware constraints and sequence length. By tuning the draft length in real time, the system can optimize the trade-off between speculative acceleration and verification overhead. Instead of using a static draft length, the system can leverage feedback on acceptance rates, forward pass latencies, and computational resource availability to determine an optimal draft size for each inference step. This adaptive approach ensures that SpD provides the highest possible speedup while minimizing performance degradation due to excessive verification costs.

Such an adaptive strategy considers the variability in hardware performance, including graphics processing unit (GPU) architecture, memory bandwidth, and parallelism capabilities. Different hardware platforms exhibit varying sensitivities to sequence length in terms of forward pass latency. A static draft length may perform well on one system but sub-optimally on another. By incorporating hardware-aware adjustments, SpD can better utilize available computational resources and maintain high efficiency across different deployment environments.

The adaptive draft length adjustment mechanism incorporates stepping point detection and real-time adjustment circuitry. This solution dynamically tunes the draft length based on underlying hardware constraints, reducing unnecessary computational overhead while maintaining drafting efficiency. By integrating hardware-aware decision-making, the system ensures smooth performance transitions across different sequence lengths, avoiding abrupt slowdowns.

The approach includes draft length adjustment logic, which monitors the acceptance rate of drafted segments and adjusts the draft length accordingly. If the acceptance rate is high, the draft length is incremented to increase drafting efficiency. Conversely, if the acceptance rate falls below the threshold, the draft length is reduced to maintain verification accuracy. However, increasing the draft length can lead to inefficient operation if a stepping point is encountered, resulting in a sudden increase in LLM verification latency. To mitigate this, stepping point detection logic is integrated into the adjustment mechanism to ensure that the draft length increments or decrements do not introduce latency spikes. The stepping point detection circuitry identifies predefined sequence lengths where verification latency exhibits sudden upward bursts. These stepping points act as decision boundaries in the draft length adjustment process. When an incremented or decremented draft length approaches a stepping point, the system evaluates whether the computational cost increase outweighs the benefits of a longer draft length. If verification latency is expected to increase significantly, the adjustment logic applies a hysteresis factor to smooth out transitions, preventing unnecessary oscillations in the draft length.

The general approach thus involves increasing K when drafting is effective, decreasing K when needed, and ensuring that the new value or adjusted value K′ does not fall into a stepping point to avoid unnecessary latency spikes. As such, the combination of draft length adjustment logic and stepping point detection circuitry provides a robust mechanism to mitigate the slowdown during LLM verification. By continuously adapting the draft length based on acceptance rates, stepping points, and real-time latency trends, the system achieves a balance between drafting efficiency and verification speed. This hardware-aware, adaptive approach ensures that LLM-powered applications can operate with minimal latency fluctuations, maximizing throughput without sacrificing accuracy.

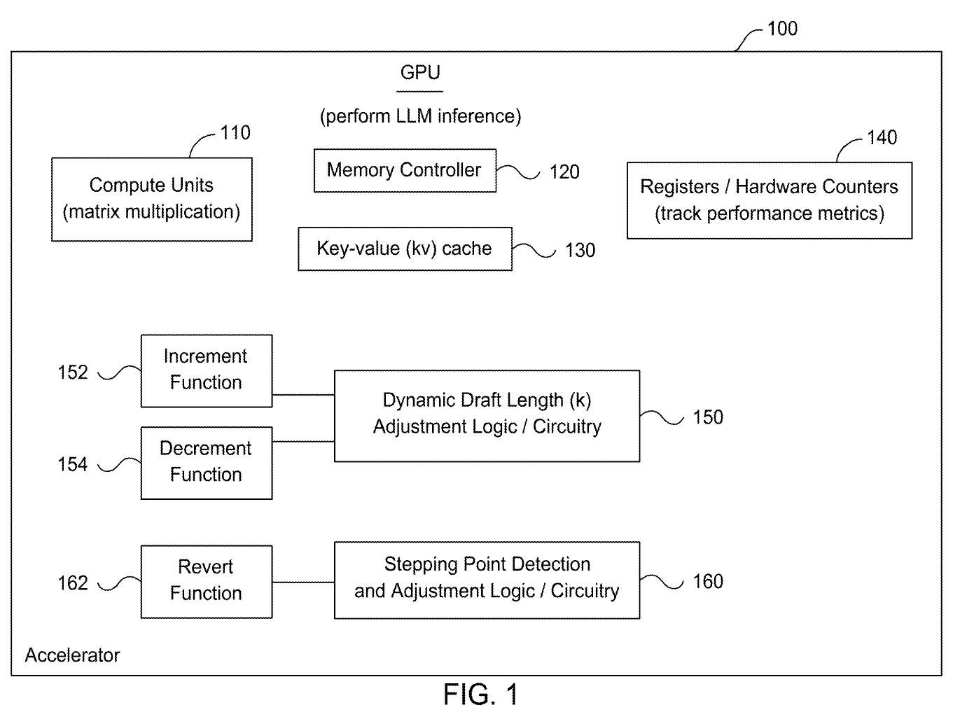

FIG. 1 illustrates an accelerator employing dynamic draft length adjustment circuitry and stepping point adjustment circuitry, according to an example.

The accelerator 100 may be a GPU for performing LLM inference. LLM inference can be accelerated using SpD. In one example, the accelerator 100 may include compute units 110 for performing, e.g., matrix multiplication, a memory controller 120, key-value (KV) cache 130, registers 140, draft length adjustment logic/circuitry 150, and stepping point detection and adjustment logic/ circuitry 160.

A LLM is a deep learning model used to understand, generate, and manipulate human language. LLMs are based on transformer architectures and are trained on massive amounts of text data to learn complex linguistic patterns, relationships, and context. LLMs have billions or even trillions of parameters, enabling sophisticated text comprehension and generation. LLMs use self-attention mechanisms to analyze long-range dependencies within text. LLMs are first pre-trained on large corpora (unsupervised learning) and later fine-tuned on specific tasks (supervised learning).

LLM inference refers to the process of generating responses from a large language model after it has been trained. LLM inference involves feeding input (e.g., a prompt or question) into the model and obtaining an output (e.g., text completion, summarization, or translation) based on the model’s learned patterns. In operation, the input text is converted into tokens (subwords or word fragments). The model processes the tokens using its transformer-based architecture (e.g., attention mechanisms) to understand context. The model predicts the most likely next token(s) based on learned probabilities. The predicted tokens are assembled into meaningful output using techniques like greedy decoding, beam search, or top-k sampling. The decoded text is converted back from tokens into human-readable text.

SpD is an artificial intelligence (AI) acceleration technique used in autoregressive language models to speed up text generation while maintaining high output quality. SpD works by generating multiple candidate sequences sequentially using a lightweight draft model and then validating them with a larger, more accurate target model. An autoregressive language model is a type of neural network that generates text by predicting the next token in a sequence based on previously generated tokens. The autoregressive language model operates in a sequential manner, where each new token is sampled from a probability distribution conditioned on all prior tokens.

In operation, SpD includes three phases or stages, that is, the drafting stage, the verification stage, and efficiency gains phase. In the drafting stage, a smaller, faster model generates multiple speculative token candidates for the next few positions in a sequence. In the verification stage, the larger target model evaluates and accepts or rejects the drafted tokens. If a token is rejected, the target model generates a replacement. In the efficiency gains phase, since the smaller model produces multiple candidate tokens in parallel, the target model processes fewer steps sequentially, reducing latency while maintaining high-quality output. As such, the drafting phase involves using the speculative model, the verification phase includes using an LLM verifier (not shown), and the efficiency gains phase is the feedback mechanism for adjusting K.

SpD is useful in LLMs where inference speed is a bottleneck. By using a lightweight draft model, SpD reduces computational overhead, leading to faster generation without sacrificing accuracy. This technique is used to optimize real-time AI applications, such as chatbots and code generation tools.

In SpD, the draft length (K) refers to the number of speculative tokens that the draft model generates in advance before being verified by the target model. The choice of K directly impacts the speed and efficiency of SpD. For a higher K, more tokens are generated speculatively, reducing the number of sequential steps needed by the target model. This can increase throughput but also raises the risk of rejected tokens, which may result in backtracking. For a lower K, fewer speculative tokens are generated, reducing the risk of incorrect drafts. This keeps the acceptance rate high but limits the acceleration benefit of SpD. In practice, K is often in the range of 2 to 10 tokens for LLMs, depending on model architecture and latency considerations.

The compute units 110 handle, e.g., matrix multiplications, attention computations, and activation functions, which are fundamental to LLM execution. In the drafting process, their role includes generating multiple tokens before verification, computing attention scores using stored key-value pairs, and ensuring that verification computations do not introduce unnecessary stalls. Since compute efficiency varies with workload size, stepping points may arise when increasing the draft length that may lead to underutilization (low parallelism) or overloading (exceeding processing capacity). The adaptive system can adjust batch sizes and workload distribution to ensure that compute units 110 remain optimally utilized.

The memory controller 120 handles data transfers between different memory hierarchies (e.g., dynamic random access memory (DRAM), static RAM (SRAM), caches) and the processing units. In the context of LLM inference and drafting, the memory controller’s role includes ensuring fast retrieval and storage of key-value pairs during attention computation, avoiding bottlenecks when fetching large sequence embeddings, and predicting token requests to minimize latency. Further, if a stepping point is memory-related (e.g., batch size increase causing a DRAM access pattern shift), the memory controller 120 can mitigate slowdowns by adjusting prefetching and scheduling policies. A well-optimized memory controller is beneficial for reducing LLM verification latency since frequent memory stalls can lead to sudden jumps in execution time.

The KV cache 130 is a memory object stored in memory used in transformer-based LLMs to store and retrieve key and value entries of previous tokens. Its significance in drafting and verification includes, by storing previously computed key and value entries, the model avoids re-computation, improving efficiency.

Registers 140 and hardware counters provide low-level control and monitoring over the drafting process. These components are embedded within processing units to track real-time system performance. For example, they can measure execution time per token, memory latency, and cache hit/miss rates, and track the current draft length value and help determine whether an increase or decrease is beneficial. Further, they can detect latency spikes and signal adjustments to prevent performance degradation. The hardware counters enable fine-grained adjustments by dynamically updating drafting behavior based on measured hardware performance rather than static heuristics.

As such, the memory controllers 120 manage efficient data movement, the KV caches 130 accelerate attention computations, the registers 140 and counters track system behavior, and the compute units 110 efficiently process token sequences.

The draft length adjustment logic/circuitry 150 monitors the acceptance rate of drafted segments and adjusts the draft length (K) accordingly. The draft length adjustment logic/circuitry 150 includes at least an increment function 152 and a decrement function 154. The acceptance rate is a metric that measures how many of the K drafted tokens from the auxiliary model are accepted by the LLM verifier without modification. If the acceptance rate is high, K is incremented to increase drafting efficiency. Conversely, if the acceptance rate falls below the threshold, K is reduced to maintain verification accuracy. However, increasing K can lead to inefficient operation if a stepping point is crossed, resulting in a sudden increase in LLM verification latency. To mitigate this, stepping point detection and adjustment logic/circuitry 160 is integrated into the adjustment mechanism to ensure that K increments or decrements do not introduce latency spikes.

The stepping point detection and adjustment logic/circuitry 160 identifies predefined sequence lengths where verification latency exhibits sudden upward bursts. Sudden upward bursts are abrupt jumps in latency or processing time at certain sequence lengths. Sudden upward bursts can also be referred to as abrupt, immediate, rapid, swift or unforeseen jumps or spikes. The latency spikes are not being measured. The latency spikes are pre-measured and may be stored in a lookup table (LUT) with target stepping points. Stated differently, the system detects but does not measure latency spikes in real-time. Once detected, such events are mapped to predefined stepping points in the LUT.

The stepping point detection and adjustment logic/circuitry 160 may include at least a revert function 162. These stepping points, obtained through initial profiling of the LLM, act as decision boundaries in the draft length adjustment process. When an incremented or decremented K approaches a stepping point, the system evaluates whether the computational cost increase outweighs the benefits of a longer draft length. If verification latency is expected to increase significantly, the adjustment logic applies a hysteresis factor to smooth out transitions, preventing unnecessary oscillations in K.

The hysteresis factor is a control parameter introduced in the stepping point detection and adjustment logic/circuitry 160 to prevent excessive oscillations in the draft length when adapting to hardware constraints, e.g., near the stepping points where inference latency undergoes sudden jumps. The hysteresis factor ensures that changes to K are made gradually and only when necessary to avoid frequent adjustments that can degrade performance. The purpose of the hysteresis factor is to prevent rapid switching, smooth out transitions, and reduce overhead.

The hysteresis factor can be set based on heuristics, e.g., as a midpoint of two consecutive jump or stepping points (fixed threshold). If profiling reveals that the LLM inference experiences latency jumps at sequence lengths K1 and K2, then the hysteresis threshold can be set to (K1 + K2) / 2, which means that adjustments to K are made when the system operates beyond this midpoint. In another example, the hysteresis factor can be dynamically set using a sophisticated function that tracks it based on the running average of acceptance rates (dynamic threshold). For example, a weighted moving average (WMA) or exponential moving average (EMA) of the acceptance rate can be used to smooth out short-term fluctuations. If the current acceptance rate deviates from the running average, K can be adjusted only when this deviation exceeds a predefined margin (hysteresis threshold).

The stepping points refer to specific sequence lengths at which the LLM model experiences a sudden increase in forward pass latency. The stepping points occur because of the way computations, memory usage, and hardware optimizations scale with increasing sequence length. When the number of tokens exceeds certain thresholds, the computational cost does not increase linearly but instead exhibits discrete jumps in latency.

Forward pass latency refers to the time taken for a single pass of input tokens through the neural network during LLM inference. The forward pass latency increases with K. The forward pass latency depends on the sequence length because of self-attention complexity, memory bandwidth and cache pressure, and batching inefficiencies.

The draft length adjustment logic/circuitry 150 and stepping point detection and adjustment logic/circuitry 160 work together to reduce slowdown during the LLM verification phase by dynamically adapting the draft length based on hardware constraints and performance characteristics. Each circuit plays a role in optimizing efficiency while avoiding performance bottlenecks.

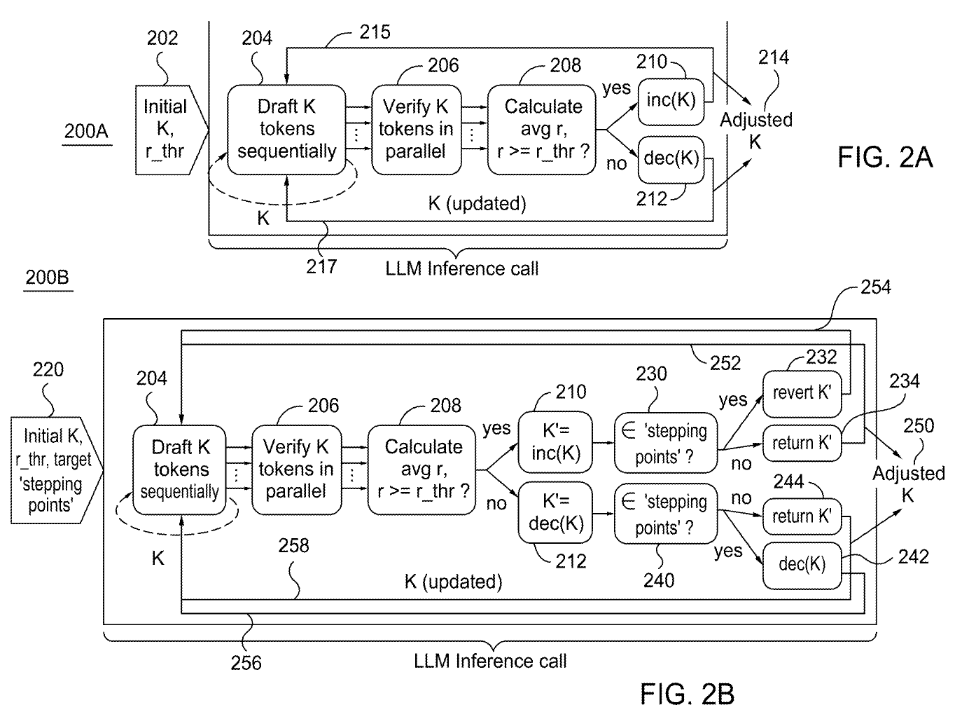

FIG. 2A illustrates employing speculative decoding (SpD) with variable draft length, according to an example.

In the process flow 200A, at operation 202, the draft length and the acceptance rate threshold are initialized. The draft length and the acceptance rate threshold may be set heuristically. Heuristically means that the draft length and the threshold for determining whether a draft token is accepted or rejected is not derived from a mathematical formula, but rather from experience, empirical observations, or practical experimentation.

At operation 204, the draft length tokens are sequentially generated. The draft length tokens refer to a batch of sequentially generated tokens produced before undergoing verification. The LLM model drafts a sequence of tokens in one pass, using its predictions to increase throughput.

At operation 206, the tokens are verified in parallel using the LLM verification circuitry. The LLM model processes all drafted tokens simultaneously using parallel attention mechanisms and batched computation. This allows the LLM model to cross-check token dependencies, refine predictions, and ensure acceptance from the target model across the generated sequence.

At operation 208, an average acceptance rate is computed. The average acceptance rate is compared to the acceptance rate threshold. The average acceptance rate is a runtime-measured metric that tracks the proportion of drafted tokens that pass verification without the need for correction. The average acceptance rate is computed over a moving window or a set number of previous drafts. A higher average acceptance rate indicates that the drafted tokens are largely correct, suggesting that increasing K may improve throughput without significantly increasing errors. A lower average acceptance rate means that a large number of drafted tokens need correction, indicating that reducing K may be necessary to improve accuracy. The acceptance rate threshold is a predefined or heuristically determined limit that dictates the minimum acceptable proportion of correctly drafted tokens before increasing K. The threshold acts as a control mechanism to prevent excessive verification overhead while maintaining token generation quality.

If the acceptance rate is greater than the acceptance rate threshold, then the draft length is incremented at operation 210. The draft length may be incremented by 1. In other words, more tokens may be drafted before verification. Stated differently, this will trigger a speedup of token generation. The auxiliary model is accurate, so the system can generate longer drafts to improve speed.

If the acceptance rate is less than the acceptance rate threshold, then the draft length is decremented at operation 212. The draft length may be decremented by 1. In other words, less tokens may need to be drafted to improve drafting accuracy and reduce verification errors. Stated differently, this will reduce drafting and verification overhead. Too many corrections are occurring, so the system needs to reduce the draft size to maintain efficiency.

By comparing the average acceptance rate against the acceptance rate threshold, the system makes informed decisions on whether to increase, decrease or maintain K to optimize the LLM throughput while preserving output accuracy.

The adjusted draft length 214 is then fed back to the operation 204. A first feedback loop 215 may be used for incremented values and a second feedback loop 217 may be used for decremented values.

The process flow 200A can be implemented using the draft length adjustment logic/circuitry 150. The function of the draft length adjustment logic/circuitry 150 is to dynamically increase or decrease the draft length K based on the LLM’s acceptance rate and performance feedback. If a high percentage of drafted content is accepted during verification, the logic increases K, allowing for more efficient drafting. If the acceptance rate drops, the logic decreases K to maintain speculative decoding accuracy. The draft length adjustment logic/circuitry 150 operates in real-time, continuously adjusting K to balance drafting efficiency and verification latency. By ensuring that the system does not draft excessively long sequences when verification is slow, it prevents unnecessary computation and reduces latency spikes.

The examples thus present a technique for adaptively adjusting the draft length K while keeping the underlying hardware in the decision-making loop for increasing or decreasing K. The specific hardware behavior that has been identified as being beneficial to the performance of SpD is the variation (super-linear increase) in the forward pass latency of an LLM (target model) with increasing K (sequence length) during the verification phase, which is denoted as t_large (verify_K). The t_large (verify_K) can help guide K at runtime in order to keep the verification latency minimal.

The following algorithm can be used:
Input: initialize K > 1, 0 < r_thr <= 1
Output: adjusted K
For every LLM inference call:
   Draft speculatively generates K tokens sequentially
   Target verifies K tokens in parallel and calculates
   r=avg(#accepted_tokens/K) (0 < r <= 1)
   If (r >= r_thr)
      K_next = min(K+1, K_max) Else K_next = max(K-1, 1)
   K = K_next

The algorithm describes the baseline technique for adaptive-K, which is often dependent on the average acceptance rate of the draft model by the LLM. In this example, K (initialized with an arbitrary small integer value) and a threshold acceptance rate (r_thr, set heuristically) are supplied as inputs. For every LLM inference call, the auxiliary model generates K tokens sequentially. These K tokens are verified in parallel by the LLM and are based on the number of tokens accepted by the LLM, and the acceptance rate (r) is calculated. If r is greater than r_thr, K is incremented by 1. Since the draft model is doing well so far, the draft length can be increased in the hopes of getting more tokens accepted in the next LLM call. On the other hand, if the acceptance rate is low (r < r_thr), K is decremented by 1 to reduce drafting overhead as well as wasted computations in the next LLM call. Increments and decrements of 1 are used in this example, but the scope of the present disclosure is not limited to specific selection of 1 token adjustment.

FIG. 2B illustrates employing SpD with hardware-guided variable draft length, according to an example.

In the process flow 200B, at operation 220, the draft length, the acceptance rate threshold, and the stepping points are initialized. The draft length, the acceptance rate threshold, and the stepping points may be set heuristically.

At operation 204, the draft length tokens are sequentially generated. The draft length tokens refer to a batch of sequentially generated tokens produced before undergoing verification. The LLM model drafts a sequence of tokens in one pass, using its predictions to increase throughput.

At operation 206, the tokens are verified in parallel using the LLM verification circuitry. The LLM model processes all drafted tokens simultaneously using parallel attention mechanisms and batched computation. This allows the LLM model to cross-check token dependencies, refine predictions, and ensure coherence across the generated sequence.

At operation 208, an average acceptance rate is computed. The average acceptance rate is compared to the acceptance rate threshold.

If the acceptance rate is greater than the acceptance rate threshold, then the draft length is incremented at operation 210. The draft length may be incremented by 1. In other words, more tokens may be drafted before verification. Stated differently, this will trigger a speedup of token generation. The auxiliary model is accurate, so the system can generate longer drafts to improve speed.

If the acceptance rate is less than the acceptance rate threshold, then the draft length is decremented at operation 212. The draft length may be decremented by 1. In other words, less tokens may need to be drafted to improve drafting accuracy and reduce verification errors. Stated differently, this will reduce verification overhead. Too many corrections are occurring, so the system needs to reduce the draft size to maintain efficiency.

By comparing the average acceptance rate against the acceptance rate threshold, the system makes informed decisions on whether to increase, decrease or maintain K to optimize the LLM throughput while preserving output accuracy. However, stepping points may be detected.

The stepping points refer to specific sequence lengths at which the LLM model experiences a sudden increase in forward pass latency. The stepping points occur because of the way computations, memory usage, and hardware optimizations scale with increasing sequence length. When the number of tokens exceeds certain thresholds, the computational cost does not increase linearly but instead exhibits discrete jumps in latency. For example, LLMs use KV cache to store previously computed token embeddings for efficient autoregressive generation. When the sequence length increases past a threshold, the memory loads or access patterns associated with the KV cache may trigger sudden latency spike.

At operation 230, if a stepping point is detected after K increases, the draft length may revert back from K’ (operation 232), to the previous K. If a stepping point is not detected after K increases, the existing K’ can be used (operation 234). Revert back means to go back to the previous K value.

At operation 240, if a stepping point is detected after K decreases, the draft length may decrement K’ further (operation 242). If a stepping point is not detected after K decreased, the existing K’ can be used (operation 244).

The adjusted K 250 is fed back using multiple feedback loops. If K has been incremented and a stepping point has been detected, a first feedback loop 252 and a second feedback loop 254 are used. If K has been decremented and a stepping point has been detected, a third feedback loop 256 and a fourth feedback loop 258 are used.

The stepping point detection and adjustment logic/circuitry 160 identifies and responds to stepping points, that is, specific sequence lengths where the LLM’s verification latency suddenly increases due to underlying hardware constraints. The stepping points are precomputed through initial profiling of the LLM on the given hardware, allowing the system to anticipate performance degradation. When the draft length adjustment logic/circuitry 150 proposes an increase or decrease in K, the stepping point detection and adjustment logic/circuitry 160 evaluates whether the new value crosses a stepping point. If an increase in K would cause a sudden spike in verification latency, the stepping point detection and adjustment logic/circuitry 160 either halts the increase or applies a hysteresis factor to smooth the transition. This prevents abrupt slowdowns and ensures that drafting remains efficient without triggering excessive computation overhead.

The adaptive-K algorithm described above with reference to FIG. 2A only considers the algorithmic properties of the workload and does not consider the effects of the underlying hardware, due to which, SpD achieves sub-optimal performance. This is because, the chosen K can be at one of the stepping points, due to which the LLM verification time is higher than expected and therefore, the overall speedup obtained from SpD will be lower than the expected theoretical speedup.

This higher verification time due to the stepping points can be mitigated by using the following algorithm:
Input: initial K > 1, 0 < r_thr <= 1, t_large_K_step, K_B_thr.
Output: hardware-adjusted K.
K_B = 0
For every LLM inference call:
   Draft speculatively generates K tokens sequentially
   Target verifies K tokens in parallel and calculates r(0 < r <= 1)
   If (r >= r_thr)
      K_next = min(K+1, K_max)
      If K_next in t_large_K_step.keys():
         K_next = K // revert to previous K
         K_B++ // back up K increments in K_B
   Else
      K_next = max(K-1, 1)
      K_B = max(0, K_B-1)
   If K_next in t_large_K_step.keys():
      K_next = K_next-1 // move next K to the left of the stepping point
   If K_B == K_B_thr:
      K_next += K_B
      K_B = 0
K = K_next

The draft length K is initialized with an arbitrarily small integer value and a threshold acceptance rate r_thr is set heuristically. Additionally, a set of parameters referred to as ‘t_large_K_step’ are provided, which is where the forward pass latency of the LLM experiences an upward jump or burst. These values are platform dependent and can be obtained through an initial benchmarking of the LLM on a given compute platform for increasing sequence lengths. Platform dependent means that such stepping points vary across different hardware and software environments. Different computing platforms have unique architectures, memory hierarchies, and computational limits that determine when the stepping points occur. For example, many AI accelerators perform computations in fixed-size matrix blocks. When a sequence length crosses a boundary, it may need an additional compute pass, causing a jump in latency.

This step is only performed once to get the relevant forward pass latencies, which can be used every time an inference request arrives. Also, an additional parameter ‘K_B_thr’ is provided, which is a metric indicating the amount of hysteresis to be introduced while updating K and can be set heuristically.

For every LLM inference call, the auxiliary model generates K tokens sequentially and these K tokens are verified in parallel by the LLM and based on the number of tokens it accepts, the acceptance rate r is calculated. If r is greater than r_thr, K_next is incremented by 1. However, at this point, the algorithm checks if this new K_next is one of the jump points of the LLM.

If so, K_next is reverted back to the previous smaller K, because otherwise the LLM will experience a higher (step increase in) verification latency for a unit increase in K, thereby losing some of the speedup benefits of SpD. At the same time, another variable, K_B is incremented to keep track of this backlog. After several such iterations of the LLM inference call, K remains constant, whereas K_backlog (K_B) keeps increasing, until it reaches the hysteresis threshold (K_B_thr), at which point, K_next is incremented by this backlog value and K_B is reset to 0 (this indicates that the acceptance rate is consistently high enough that there is reason to gain overall in terms of throughput from the larger draft length in spite of the higher verification cost).

Finally, similar to the algorithm of FIG. 2A, if the LLM has a lower acceptance rate than the threshold, K_next is set to K-1. At this point, an additional check is performed, which ensures that if this new K is one of the jump points, it is decremented by 1, that is, K is moved to the immediate left of this jump point to avoid paying the higher verification latency cost at the jump point. Increments and decrements of 1 are used in this example, but the scope of the present disclosure is not limited to specific selection of 1 token adjustment.

To summarize, during initialization, the stepping points obtained from initial profiling of the LLM on a given platform are provided, in addition to the initial K value and threshold acceptance rate (r_thr). The draft model generates K tokens sequentially, the target model verifies the K tokens in parallel, and the average acceptance rate r is calculated. If r is greater than the given threshold, K is incremented, otherwise it is decremented (K’). If K’ happens to be one of the stepping points, it is moved to the left of the stepping point (reverted back to the previous K) to avoid paying a higher verification latency cost. Otherwise, K’ is returned as is.

Integrating the draft length adjustment logic/circuitry 150 and the stepping point detection and adjustment logic/circuitry 160 into the LLM drafting process provides significant performance and efficiency gains by dynamically tuning the draft length based on hardware constraints and real-time performance feedback. The benefits include optimized drafting efficiency, reduced LLM verification latency, hardware-aware adaptation, avoidance of performance bottlenecks, and stable and predictable system behavior.

The K adjustment logic ensures that the system drafts the longest possible sequences while maintaining a high acceptance rate, reducing the frequency of verification interruptions. By dynamically adapting K, the system minimizes wasted computation from excessive rejections while maximizing throughput.

Stepping point detection logic prevents sudden spikes in verification latency by identifying critical sequence lengths where performance degradation occurs. This proactive avoidance of high-latency regions enables smoother verification, preventing unpredictable slowdowns.

The combined logic adapts to the underlying hardware architecture, ensuring that drafting operates within optimal performance zones specific to the accelerator, GPU, or CPU used. Instead of relying on fixed heuristics, real-time feedback loops allow for dynamic and efficient operation across different hardware configurations.

Without stepping point detection, increasing K arbitrarily may result in severe slowdowns when crossing hardware-imposed thresholds. The stepping point adjustment logic prevents excessive computation overhead, ensuring that drafting adjustments do not trigger unnecessary performance degradation.

The system integrates hysteresis mechanisms to prevent abrupt oscillations in K, ensuring stability in draft length adjustments. This avoids excessive fluctuations, maintaining consistent performance trends rather than erratic drafting speeds.

By keeping drafting as efficient as possible while avoiding verification slowdowns, the system maximizes overall LLM processing speed. This is beneficial for real-time AI applications, where maintaining smooth and responsive behavior is valuable.

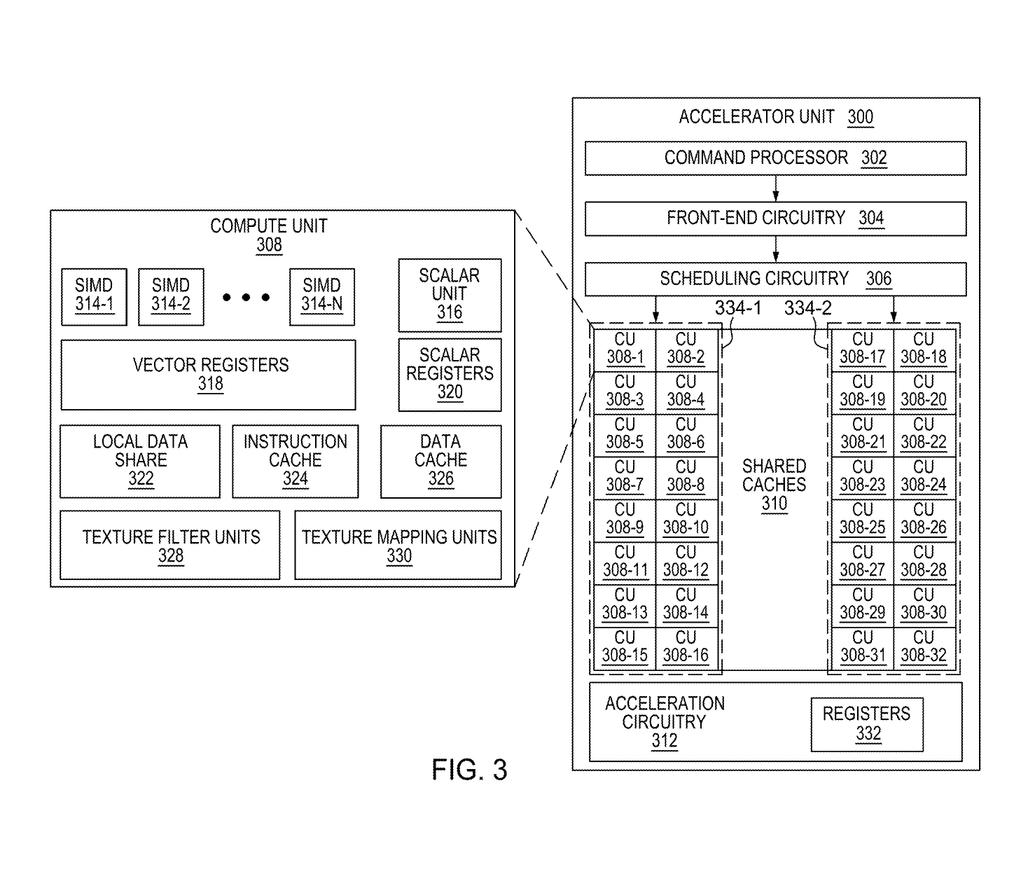

FIG. 3 is a block diagram of an accelerator unit (AU) configured to execute workloads for applications running on a processing system, in accordance with some examples.

FIG. 3 presents an AU 300 configured to execute workloads for one or more applications running on a processing system. These applications include, for example, compute applications, graphics applications, or both each configured to issue respective series of instructions, also referred to herein as “threads,” to a central processing unit (CPU) of the processing system. Compute applications, when executed by a processing system, cause the processing system to perform one or more computations, such as machine-learning, neural network, high-performance computing, or databasing computations. Further, graphics applications, when executed by a processing system, cause the processing system to render a scene including one or more graphics objects and, as an example, output the scene on a display. The instructions issued to the CPU from these applications, for example, include groups of threads, also referred to herein as “workgroups,” to be executed by AU 300. To perform these workgroups, AU 300 includes one or more vector processors, coprocessors, graphics processing units (GPUs), general-purpose GPUs, non-scalar processors, highly parallel processors, artificial intelligence (AI) processors, inference engines, AI engines, AI engine cores, machine-learning processors, or any combination thereof. As an example, AU 300 includes one or more command processors 302, front-end circuitry 304, scheduling circuitry 306, compute units 308, shared caches 310, and acceleration circuitry 312.

A command processor 302 of AU 300 is configured to receive, from the CPU, a command stream indicating one or more workgroups to be executed. As an example, based on a compute application running on the processing system, the command processor 302 receives a command stream indicating workgroups that involve compute operations such as matrix multiplication, addition, subtraction, and the like to be performed. As another example, based on a graphics application running on the processing system, the command processor 302 receives a command stream indicating workgroups that include draw calls for a scene to be rendered. After receiving a command stream, the command processor 302 parses the command stream and issues respective instructions of the indicated workgroups to front-end circuitry 304, scheduling circuitry 306, or both. As an example, based on a command stream from a graphics application, the command processor 302 issues one or more draw calls to front-end circuitry 304 that includes one or more vertex shaders, polygon list builders, and the like. From the instructions issued from the command processor 302, front-end circuitry 304 is configured to position geometry objects in a scene, assemble primitives in a scene, cull primitives, perform visibility passes for primitives in a scene, generate visible primitive lists for a scene, or any combination thereof. For example, based on a set of draw calls received from a command processor 302, front-end circuitry 304 determines a list of primitives to be rendered for a scene. After determining a list of primitives to be rendered for a scene, the front-end circuitry 304 issues one or more draw calls (e.g., a workgroup) associated with the primitives in the list of primitives to scheduling circuitry 306.

Based on the instructions of the workgroups received from a command processor 302, front-end circuitry 304, or both, scheduler circuitry 306 is configured to provide data indicating threads (e.g., operations for these threads) to be executed for these workgroups to one or more compute units 308. Each compute unit 308 is configured to support the concurrent execution of two or more threads of a workgroup. For example, each compute unit 308 is configured to concurrently execute a predetermined number of threads referred to herein as a “wavefront.” Based on the size of the wavefront of a compute unit 308, scheduler circuitry 306 schedules one or more groups of threads of the workgroup, also referred to herein as “waves,” to be executed by the compute unit 308. As an example, scheduler circuitry 306 first updates one or more registers of a compute unit 308 such that the compute unit 308 is configured to execute a first group of waves of the workgroup. After the compute unit 308 has executed the first group of waves, scheduler circuitry 306 updates one or more registers of the compute unit 308 to schedule a second group of waves of the workgroup to be executed by the compute unit 308. To execute these waves, each compute unit is connected to one or more shared caches 310 that each include a volatile memory, non-volatile memory, or both accessible by one or more compute units 308. These shared caches 310, for example, are configured to store data (e.g., register files, values, operands, instructions, variables) used in the execution of one or more waves, data resulting from the performance of one or more waves, or both. Because a shared cache 310 is accessible by two or more compute units 308, a first compute unit 308 is enabled to provide results from the execution of a first wave to a second compute unit 308 executing a second wave. Though the examples presented in FIG. 3 shows AU 300 as including 32 compute units (308-1 to 308-32), in other implementations, AU 300 can include any number of compute units 308.

Each compute unit 308 includes one or more single instruction, multiple data (SIMD) units 314, a scalar unit 316, vector registers 318, scalar registers 320, local data share 322, instruction cache 324, data cache 326, texture filter units 328, texture mapping units 330, or any combination thereof. A SIMD unit 314 (e.g., a vector processor) is configured to concurrently perform multiple instances of the same operation for a wave. For example, a SIMD unit 314 includes two or more lanes each including an arithmetic logic unit (ALU) and each configured to perform the same operation for the threads of a wave. Though the examples presented in FIG. 3 shows a compute unit 308 including three SIMD units (314-1, 314-2, 314-N) representing an N number of SIMD units, in other implementations, a compute unit 308 can include any number of SIMD units 314. Further, as an example, the size of a wavefront supported by AU 300 is based on the number of SIMD units 314 included in each compute unit 308. To determine the operations performed by the SIMD units 314, each compute unit 308 includes vector registers 318 formed from one or more physical registers of AU 300. These vector registers 318 are configured to store data (e.g., operands, values) used by the respective lanes of the SIMD units 314 to perform a corresponding operation for the wave. Additionally, each compute unit 308 includes a scalar unit 316 configured to perform scalar operations for the wave. As an example, the scalar unit 316 includes an ALU configured to perform scalar operations. To support the scalar unit 316, each compute unit 308 includes scalar registers 320 formed from one or more physical registers of accelerator unit 300. These scalar registers 320 store data (e.g., operands, values) used by the scalar unit 316 to perform a corresponding scalar operation for the wave.

Further, each compute unit 308 includes a local data share 322 formed from a volatile memory (e.g., random-access memory) accessible by each SIMD unit 314 and the scalar unit 316 of the compute unit 308. That is to say, the local data share 322 is shared across each wave concurrently executing on the compute unit 308. The local data share 322 is configured to store data resulting from the execution of one or more operations for one or more waves, data (e.g., register files, values, operands, instructions, variables) used in the execution of one or operations for one or more waves, or both. As an example, the local data share 322 is used as a scratch memory to store results necessary for, aiding in, or helpful for the performance of one or more operations by one or more SIMD units 314. The instruction cache 324 of a compute unit 308, for example, includes a volatile memory, non-volatile memory, or both configured to store the instructions to be executed for one or more waves to be executed by the compute unit 308. Further, the data cache 326 of a compute unit 308 includes a volatile memory, non-volatile memory, or both configured to store data (e.g., register files, values, operands, variables) used in the execution of one or more waves by the compute unit 308. The instruction cache 324, data cache 326, shared caches 310, and a system memory, for example, are arranged in a hierarchy based on the respective sizes of the caches. As an example, based on such a cache hierarchy, a compute unit 308 first requests data from a controller of a corresponding data cache 326. Based on the data not being in the data cache 326, the data cache 326 requests the data from a shared cache 310 at the next level of the cache hierarchy. The caches then continue in this way until the data is found in a cache or requested from the system memory, at which point, the data is returned to the compute unit 308. Additionally, each compute unit 308 includes one or more texture mapping units 330 each including circuitry configured to map textures to one or more graphics objects (e.g., groups of primitives) generated by the compute units 308. Further, each compute unit 308 includes one or more texture filter units 328 each having circuitry configured to filter the textures applied to the generated graphics objects. For example, the texture filter units 328 are configured to perform one or more magnification operations, anti-aliasing operations, or both to filter a texture.

Additionally, to help perform instructions for one or more workgroups, AU 300 includes acceleration circuitry 312. Such acceleration circuitry 312 includes hardware (e.g., fixed-function hardware) configured to execute one or more instructions for one or more workgroups. As an example, acceleration circuitry 312 includes one or more instances of fixed function hardware configured to encode frames, encode audio, decode frames, decode audio, display frames, output audio, perform matrix multiplication, or any combination thereof. To schedule instructions for execution on such hardware, scheduling circuitry 306 is configured to update one or more physical registers 332 of AU 300 associated with the hardware. In some cases, AU 300 includes one or more compute units 308 grouped into one or more shader engines 334. Referring to the implementation presented in FIG. 3, for example, AU 300 includes compute units 308-1 to 308-16 grouped in a first shader engine 334-1 and compute units 308-17 to 308-32 grouped in a second shader engine 334-2. Such shader engines 334, for example, are configured to execute one or more workgroups (e.g., one or more compute kernels) for an application and include one or more compute units 308, graphics processing hardware (e.g., primitive assemblers, rasterizers), one or more shared caches 310, render backends, or any combination thereof. Though the example presented in FIG. 3 shows AU 300 as including two shader engines (334-1, 334-2), in other implementations, AU 300 can include any number of shader engines (334-1, 334-2).

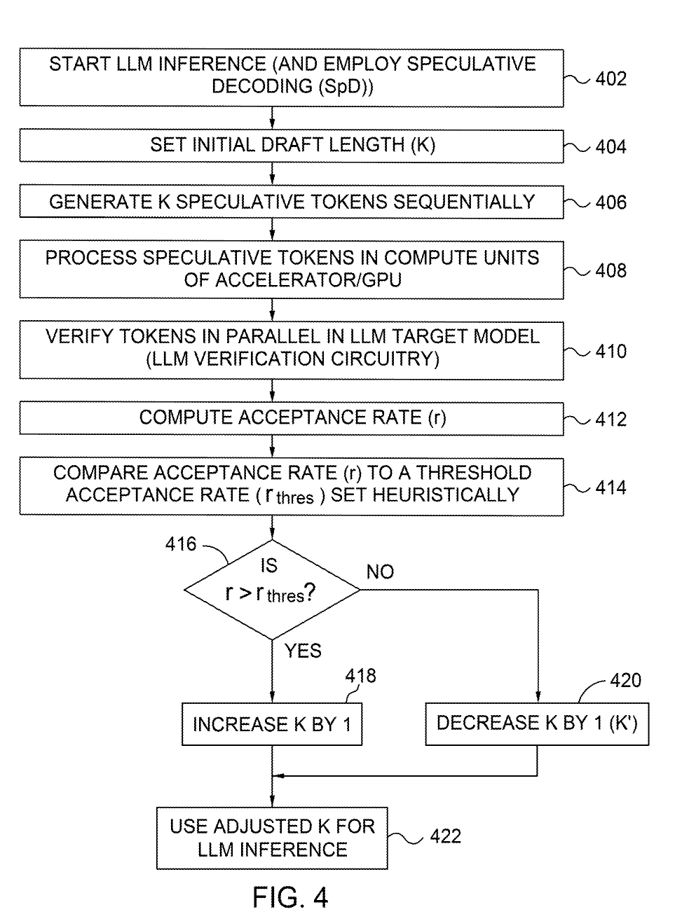

FIG. 4 illustrates a method for employing SpD with variable draft length, according to an example.

At 402, an accelerator starts an LLM inference by employing speculative decoding (SpD). SpD is an AI acceleration technique used in autoregressive language models to speed up text generation while maintaining high output quality.

At 404, a user sets the initial draft length (K). The draft length refers to the number of speculative tokens that the draft model generates in advance before being verified by the target model. The choice of K directly impacts the speed and efficiency of SpD.

At 406, a token predictor of the draft model sequentially generates K speculative tokens.

At 408, compute units in the accelerator or GPU process the speculative tokens. The accelerator may be based on the accelerator unit 300 of FIG. 3. The accelerator may also be, e.g., any type of field-programmable gate array (FPGA) or application-specific integrated circuit (ASIC).

At 410, the LLM verifier verifies the tokens in parallel in the LLM target model. The LLM verifier checks how many tokens match its predictions.

At 412, the LLM model computes the acceptance rate (r). The acceptance rate is a metric that measures how many of the K drafted tokens from the auxiliary model are accepted by the LLM verifier without modification.

At 414, the LLM model compares the acceptance rate (r) to a threshold acceptance rate (rₜₕᵣₑₛ) that is set heuristically. The threshold acceptance rate is the minimum fraction of tokens that are accepted before increasing draft length.

At 416, the LLM model determines whether the acceptance rate is greater than the threshold acceptance rate. If YES, at 418, the draft length is incremented. In one example, the draft length is incremented by 1. If NO, at 420, the draft length is decremented. In one example, the draft length is decremented by 1.

At 422, the LLM model uses, e.g., the first feedback loop 215 and the second feedback loop 217 to feed back the adjusted draft length to be used for the LLM inference to optimize performance. The feedback loops allow the LLM inference process to adapt dynamically to platform-specific stepping points, preventing unnecessary slowdowns due to inefficient draft lengths. By continuously monitoring the average acceptance rate and comparing it to the threshold, the system ensures that K is neither too small nor too big.

The method can be summarized as follows:
The token predictor generates a speculative draft with length K. The compute units process the tokens, using KV cache for efficient lookups. The LLM verifier checks if the tokens are correct. The acceptance rate (r) is computed based on verified versus rejected tokens. A comparison is made between the acceptance rate (r) and the threshold acceptance rate (T). If r > T (most tokens are accepted), increase K for higher speedup. If r < T (many tokens are rejected), decrease K to improve accuracy. A hardware performance-based adjustment can be made by checking the GPU utilization, KV cache efficiency, and memory bandwidth. The K can be adjusted up or down to ensure optimal balance between compute and memory bottlenecks. The loop continues until the full LLM sequence is generated.

The benefits include maximizing LLM drafting efficiency while minimizing verification delays, avoiding unnecessary latency spikes caused by stepping points, ensuring smooth and stable drafting behavior without frequent oscillations in K, and adapting to underlying hardware constraints, making the system more robust across different platforms.

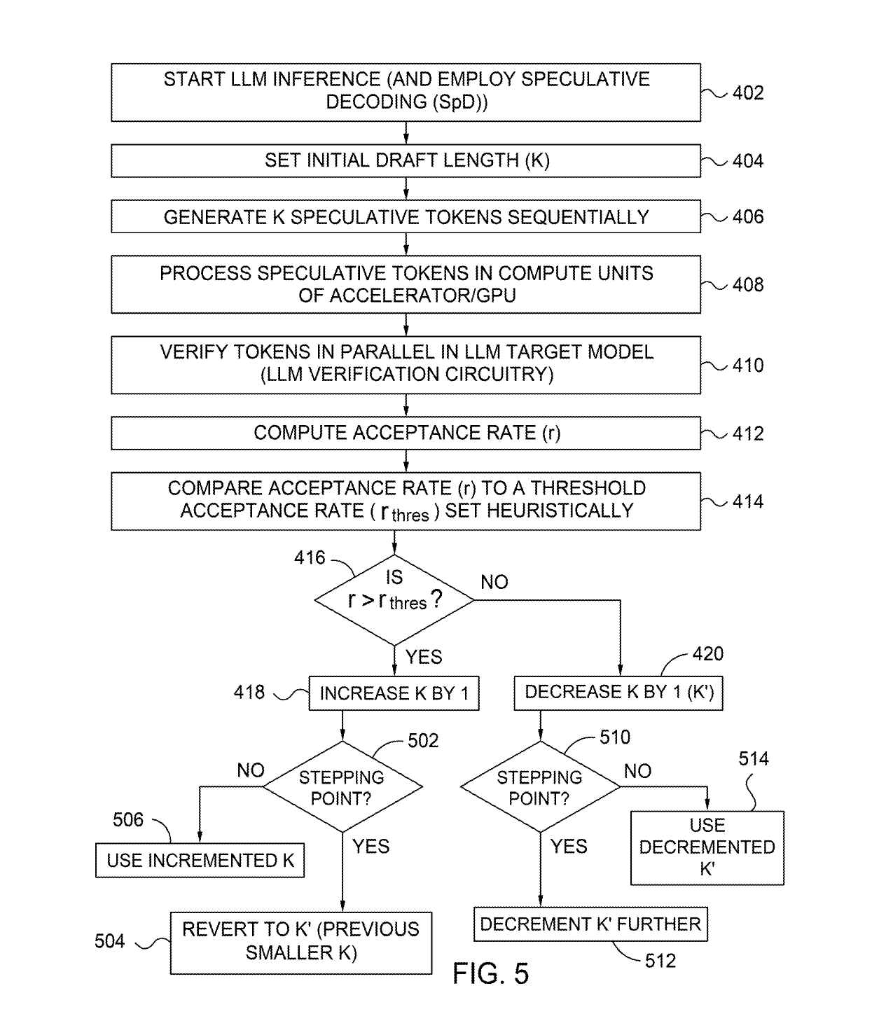

FIG. 5 illustrates a method for employing SpD with hardware-guided variable draft length, according to an example.

Operations 402 to 420 are the same as in FIG. 4 and their description will be omitted for sake of conciseness.

At operation 502, the stepping point detection and adjustment logic/circuitry 160 determines whether a stepping point has been detected (after the incrementing operation 418). Stepping points refer to specific points at which the verification latency of the LLM experiences a sudden increase rather than growing smoothly. These are threshold effects where certain factors, such as context length, computational resource constraints, or internal batching mechanisms, cause a discontinuous jump in processing time. The slowdown becomes more pronounced for larger draft lengths due to higher drafting overhead (as more text is drafted before verification, the accumulated processing cost rises) and LLM verification latency (the time needed to verify drafted text increases non-linearly, with abrupt jumps at stepping points.)

If YES, the operation proceeds to operation 504 where the draft length is reverted back to the previous draft length because otherwise the LLM will experience a higher (step increase in) verification latency for a unit increase in K, thereby losing some of the speedup benefits of SpD. If NO, the process proceeds to operation 506 when the incremented K (from operation 418) is used.

At operation 510, the stepping point detection and adjustment logic/circuitry 160 determines whether a stepping point has been detected (after the decrementing operation 420). If YES, the operation proceeds to operation 512 where the draft length is decremented even further. If NO, the process proceeds to operation 514 when the decremented K (from operation 420) is used.

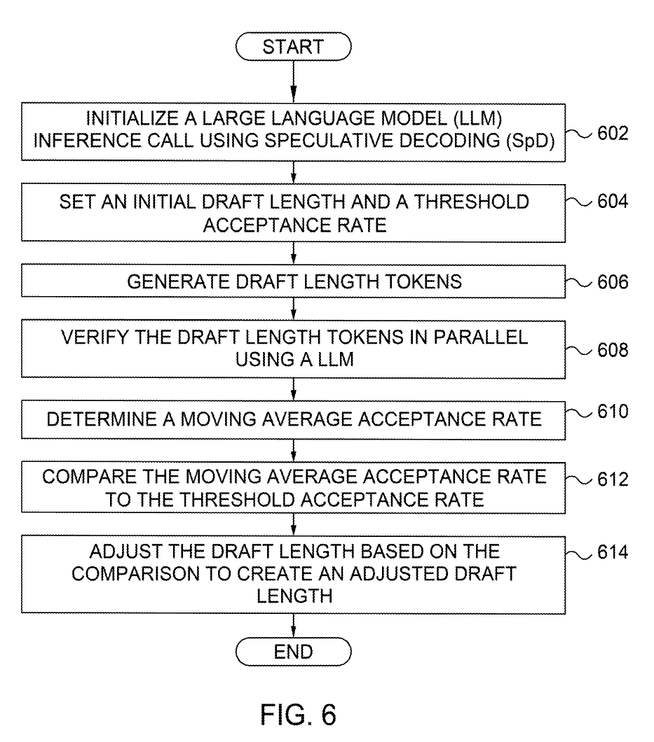

FIG. 6 illustrates a method for adjusting the draft length based on a comparison between a moving average acceptance rate and a threshold acceptance rate comparison to create an adjusted draft length, according to an example.

At 602, an accelerator initializes the LLM inference call using SpD.

At 604, a user sets the initial draft length and the threshold acceptance rate.

At 606, the token predictor of the draft model generates draft length tokens.

At 608, the LLM verifier verifies the draft length tokens in parallel using the LLM.

At 610, the LLM model determines a moving average acceptance rate.

At 612, the LLM model compares the moving average acceptance rate to the threshold acceptance rate.

At 614, the draft length adjustment logic/circuitry 150 adjusts the draft length based on the comparison to create an adjusted draft length.

In conclusion, while SpD offers significant speedups in token generation, the actual gains observed in practice often fall short of the ideal theoretical speedups. The reason for this deviation lies in the linear increase in execution time of the LLM during the verification phase as the draft length (K) increases. This trend becomes more severe at stepping points, where the forward pass latency undergoes sudden upward jumps, causing significant slowdowns in token verification. As a result, even though increasing K allows for more tokens to be processed at once, the overall system efficiency may suffer due to these hidden latency spikes.

To mitigate this issue, the example approach focuses on reducing the slowdown during LLM verification by making draft length adjustments aware of the underlying hardware constraints. First, K is increased or decreased based on the acceptance rate threshold, and second, the K is further adjusted based on detected stepping points. This ensures that the draft length is not only optimized for accuracy but also for execution efficiency, avoiding unnecessary verification bottlenecks.

As such, if the acceptance rate is above a predefined threshold, K is incremented to improve efficiency by generating more tokens at once. If the acceptance rate falls below the threshold, K is decremented to enhance verification accuracy. However, if the new or adjusted draft length K′ falls on a stepping point, where verification latency would spike, it is shifted left (reverted back to previous K value) to avoid the increased execution cost. This ensures that the system does not encounter unnecessary slowdowns while adapting to the LLM’s capabilities. By keeping the underlying hardware in the decision-making loop, the solution prevents unexpected latency jumps that would otherwise degrade performance. The trade-off between drafting length and verification cost is dynamically managed, ensuring that the system remains in an optimal operating region.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An accelerator comprising:
draft length adjustment circuitry configured to:
determine a moving average acceptance rate for draft length tokens sequentially generated for a large language model (LLM) inference call using speculative decoding (SpD); and
adjust a draft length based on the moving average acceptance rate to create an adjusted draft length.

2. The accelerator of claim 1, wherein the draft length is incremented when the moving average acceptance rate is greater than a threshold acceptance rate.

3. The accelerator of claim 1, wherein the draft length is decremented when the moving average acceptance rate is less than a threshold acceptance rate.

4. The accelerator of claim 1, wherein the accelerator comprises stepping point detection and adjustment circuitry configured to identify, after the adjusted draft length has been created, draft sequence lengths defined as stepping points that exhibit sudden upward bursts.

5. The accelerator of claim 4, wherein, when a stepping point has been identified after the draft length has been decremented, the adjusted draft length is further decremented.

6. The accelerator of claim 4, wherein, when a stepping point has been identified after the draft length has been incremented, the adjusted draft length is reverted back to a previous draft length.

7. The accelerator of claim 6, wherein a hysteresis factor is applied to revert back the adjusted draft length.

8. The accelerator of claim 7, wherein the hysteresis factor is set at a midpoint of two consecutive stepping points.

9. The accelerator of claim 7, wherein the hysteresis factor is dynamically set using a function that tracks it based on a running average of acceptance rates.

10. The accelerator of claim 1, wherein the accelerator is a graphics processing unit (GPU).

11. A processor comprising:
draft length adjustment circuitry configured to generate draft length tokens for a large language model (LLM) inference call using an artificial intelligence (AI) acceleration technique; and
stepping point detection and adjustment circuitry configured to identify, after the draft length adjustment circuitry has been used to adjust a draft length, draft sequence lengths defined as stepping points that exhibit abrupt upward spikes in latency.

12. The processor of claim 11, wherein the processor is a graphics processing unit (GPU).

13. The processor of claim 11, wherein the AI acceleration technique is speculative decoding (SpD).

14. The processor of claim 11, wherein the draft length adjustment circuitry is configured to determine a moving average acceptance rate for the generated draft length tokens and compare the moving average acceptance rate to a threshold acceptance rate to adjust the draft length.

15. The processor of claim 14, wherein the draft length is decremented when the moving average acceptance rate is less than the threshold acceptance rate.

16. The processor of claim 14, wherein the draft length is incremented when the moving average acceptance rate is greater than the threshold acceptance rate.

17. The processor of claim 16, wherein, when a stepping point has been identified after the draft length has been incremented, the adjusted draft length is reverted back to a previous draft length by applying a hysteresis factor.

18. A method comprising:
initializing a large language model (LLM) inference call using speculative decoding (SpD);
generating draft length tokens with an initial draft length;
verifying the draft length tokens in parallel using a LLM;
determining a moving average acceptance rate; and
adjusting the draft length based on the moving average acceptance rate to create an adjusted draft length.

19. The method of claim 18, further comprising, after the adjusted draft length has been created, identifying draft sequence lengths defined as stepping points that exhibit sudden upward bursts.

20. The method of claim 19,
wherein, when a stepping point has been identified after the draft length has been decremented, the adjusted draft length is further decremented; and
wherein, when a stepping point has been identified after the draft length has been incremented, the adjusted draft length is reverted back to a previous draft length.
